(19) United States
(12) Patent Application Publication
(10) Pub. No.: US 2011/0234748 A1
(43) Pub. Date: Sep. 29, 2011

(54) IMAGE PROCESSING DEVICE AND IMAGE PROCESSING METHOD

(75) Inventor: Kazuaki TERASHIMA, Kanagawa (JP)

(73) Assignee: RENESAS ELECTRONICS CORPORATION

(21) Appl. No.: 13/074,414

(22) Filed: Mar. 29, 2011

(30) Foreign Application Priority Data
Mar. 29, 2010 (JP) 2010-075342

(51) Int. Cl. H04N 5/00

(52) U.S. Cl. 348/25; 348/E05.001

(57) ABSTRACT

To provide an image processing device capable of processing so as not to give a viewer a feeling of unnaturalness even when a crash occurs in the frame interpolation processing using motion vectors. It is determined whether there is any input of a vector state (Step S0). If it has been determined that there is an input of a vector state, then based on the vector state, it is determined whether a vector evaluation calculation range is within an effective range (Step S2). If it has been determined based on the vector state that the vector evaluation calculation range is not within an effective range, then the flow moves to a ratio signal adjusting mode. With regard to the adjustment of the ratio signal, once having moved to the ratio signal adjusting mode, first, as an example, the ratio signal is set to 1/3 in generating an interpolation frame, and then in the generation of the next interpolation frame, the ratio signal is set to 1/5. Then, the ratio signal is set to 0 in the generation of the next interpolation frame.

### CROSS-REFERENCE TO RELATED APPLICATION

The disclosure of Japanese Patent Application No. 2010-75342 filed on Mar. 29, 2010 including the specification, drawings and abstract is incorporated herein by reference in its entirety.

### BACKGROUND OF THE INVENTION

The present invention relates to image processing devices and frame rate conversion processing.

As compared with conventional cathode-ray tubes (CRTs) primarily used, LCDs (Liquid Crystal Displays) have a problem, so-called motion blur, which is the blurring of outline of a moving portion perceived by a viewer when displaying a moving image.

With regard to this point, since fluorescent material is scanned by an electron beam to cause emission of light for display for each pixel in CRTs, the light emission of each pixel is basically impulse-like although slight afterglow of the fluorescent material exists.

In contrast, in the case of LCDs, an electric charge is accumulated by applying an electric field to liquid crystal and is retained at a relatively high ratio until the next electric field is applied. Especially, in the case of the TFT system, since a TFT switch is provided for each dot comprising a pixel and each pixel usually has an auxiliary capacity, the ability to retain the accumulated charge is extremely high. Therefore, the light emission is continued until the pixels are rewritten by the application of the electric field based on the image information of the next frame or field (hereinafter, generically referred to as the frame). For this reason, the impulse response of the image displaying light has a temporal spread, and therefore temporal frequency properties deteriorate and accordingly spatial frequency properties also deteriorate, resulting in the motion blur (afterimage). Since the human eye can smoothly follow a moving object, if the light emission time is long, the movement of an image becomes jerky and looks unnatural due to the time integration effect.

In order to improve this motion blur, there is known a technology in which a frame rate (the number of frames) is converted by interpolating an image between frames. This technology is called FRC (Frame Rate Converter) and has already been put to practical use in liquid crystal displaying devices, or the like.

Conventionally known methods of converting the frame rate include various techniques, such as simply repeating read-out of the same frame a plurality of times and frame interpolation using linear interpolation between frames.

However, in the case of the frame interpolation processing using the linear interpolation, unnaturalness of motion (jerkiness, judder) is generated, resulting in inadequate image quality.

In order to eliminate an influence of the unnaturalness, etc., and improve the quality of moving images, a frame interpolation processing using motion vectors has been proposed.

According to this frame interpolation processing using motion vectors, since frames are interpolated under a dynamic prediction using the motion vectors, highly natural moving images may be acquired without deteriorating the resolution and generating the jerkiness.

For example, the frame interpolation processing using the motion vectors converts the frame rate of an input image signal from 60 frames per second (60 Hz) to 120 frames per second (120 Hz).

In this manner, by performing the motion-compensated frame interpolation processing with the use of the motion vectors and increasing a display frame frequency, the display state of the LCD can be made closer to the display state of the CRT (the impulse display mode) and the deterioration of an image due to the motion blur generated when displaying a moving image can be improved.

In the frame interpolation processing using motion vectors, it is essential to detect the motion vectors for performing motion compensation. For example, the block matching method, the gradient method, and the like have been proposed as representative techniques for the motion vector detection. In these methods, the motion vector is detected for each pixel or small block between two consecutive frames and thereby each pixel or small block of the interpolation frame between two frames is interpolated using these motion vectors. That is, an image at an arbitrary position between two frames is moved to an accurate position to be interpolated so that the number of frames is converted.

In attempting to realize the FRC by real-time processing using hardware or by simulation processing using a computer, etc., the calculation ranges in evaluating the motion vector practically need to be restricted due to the constraint on the circuit configuration in hardware, the memory area, the processing speed in a computer, etc.

For example, when the moving amount between frames is large, the motion vector calculated by the gradient method calculation may exceed a restricted vector evaluation calculation range. That is, in the gradient method calculation, because the vector is calculated by mathematical calculation based on a difference in the gradient of the image information of the previous and subsequent frames, a vector exceeding the restricted vector evaluation calculation range may be calculated.

As described above, when the vector calculated by the gradient method calculation exceeded the vector evaluation calculation range, a special processing is performed to output some sort of vector. However, this output vector is not the one truly reflected by the calculation result of the gradient method, etc., and is not the accurate motion vector. Therefore, if the frame interpolation processing is performed using the motion vector having been subjected to such a special processing, a crash may occur in the interpolation frame.

Note that, not only when the gradient method is used as the motion vector detection method, but also, for example, when the block matching method is used, it is necessary to put restrictions on the vector search range etc., and as with the above, for example, if the moving amount between frames is large, it is difficult to output an accurate motion vector and a crash may occur in the interpolation frame.

Various methods have been proposed in order to cope with this crash in the interpolation frame ((Japanese Patent Laid-Open No. 2009-135641 (Patent Document 1), Japanese Patent Laid-Open No. 2008-135980 (Patent Document 2), Japanese Patent Laid-Open No. 2009-182935 (Patent Document 3), Japanese Patent Laid-Open No. 2007-74588 (Patent Document 4), and Japanese Patent Laid-Open No. 2009-159332 (Patent Document 5)).

In this point, Patent Document 1 proposes a method of preventing the interpolation frame, in which a crash would occur, from being output.

### SUMMARY OF THE INVENTION

However, as shown in Patent Document 1, if an interpolated (combined) frame is not to be suddenly output when a crash occurs, the image becomes unnatural at a time point of the boundary for turning on/off the output of the interpolation frame, which may give a viewer a feeling of unnaturalness.

The present invention has been made in order to solve the problems as described above, and provides an image processing device capable of processing so as not to give a viewer a feeling of unnaturalness even when a crash occurs in the frame interpolation processing using motion vectors, and an image processing method.

An image processing device according to an embodiment of the present invention converts the number of frames of an input image signal by interpolating an image signal between consecutive frames of the input image signal. The image processing device comprises: a motion vector calculation section calculating a motion vector based on one of the consecutive frames of the input image signal, and the other frame; and a vector analysis section determining the reliability of a motion vector calculated by the motion vector calculation section. The image processing device further comprises an interpolation ratio setting section setting an interpolation ratio for interpolating between one of the consecutive frames and the other frame based on the analysis result of the vector analysis section. The image processing device further comprises an interpolation frame generation section generating an interpolation frame for interpolating between one of the consecutive frames and the other frame based on the motion vector calculated by the motion vector calculation section and the interpolation ratio. The interpolation ratio setting section gradually changes the interpolation ratio from a predetermined interpolation ratio based on the analysis result of the vector analysis section.

According to the embodiment of the present invention, since the interpolation ratio setting section gradually changes the interpolation ratio from a predetermined interpolation ratio based on the analysis result of the vector analysis section, the image processing device can alleviate a feeling of unnaturalness due to a drastic change in the interpolation ratio.

### BRIEF DESCRIPTION OF THE DRAWINGS

FIG. 1 is a block diagram illustrating a configuration example of a frame rate conversion section according to an embodiment of the present invention;

FIG. 2 is a view illustrating the generation of an interpolation frame using key frames;

FIG. 3 is a view illustrating an interpolation ratio when an interpolation frame is generated;

FIG. 4 is a view illustrating the generation of a normal interpolation frame using key frames when a ratio signal is set to 1/2;

FIG. 5 is a view illustrating a conventional processing when an interpolation frame based on two key frames is not generated;

FIG. 6 is a view illustrating the generation of an interpolation frame according to the embodiment of the present invention;

FIG. 7 is a flow diagram illustrating an adjustment processing from the ratio signal 1/2 in a memory management section 4 according to the embodiment of the present invention;

FIG. 8 is a flow diagram illustrating the adjustment processing from a ratio signal 0 in the memory management section 4 according to the embodiment of the present invention;

FIG. 9A is a view illustrating a change in the ratio signal of the embodiment of the present invention;

FIG. 9B is a view illustrating a change in the conventional ratio signal;

FIG. 10 is a block diagram illustrating a configuration example of a frame rate conversion section according to an alternative embodiment of the present invention;

FIG. 11 is a flow diagram illustrating the adjustment processing from the ratio signal 1/2 in the memory management section 4 according to the alternative embodiment of the present invention;

FIG. 12 is a flow diagram illustrating the adjustment processing from the ratio signal 0 in the memory management section 4 according to the alternative embodiment of the present invention;

FIG. 13A is a view illustrating a change in the ratio signal according to the alternative embodiment of the present invention; and

FIG. 13B is a view illustrating a change in the conventional ratio signal.

### DETAILED DESCRIPTION OF THE PREFERRED EMBODIMENTS

Hereinafter, the embodiments of the present invention will be described in detail with reference to the accompanying drawings. Note that the same symbol is attached to the same or equivalent member in the views and the explanation thereof is not repeated.

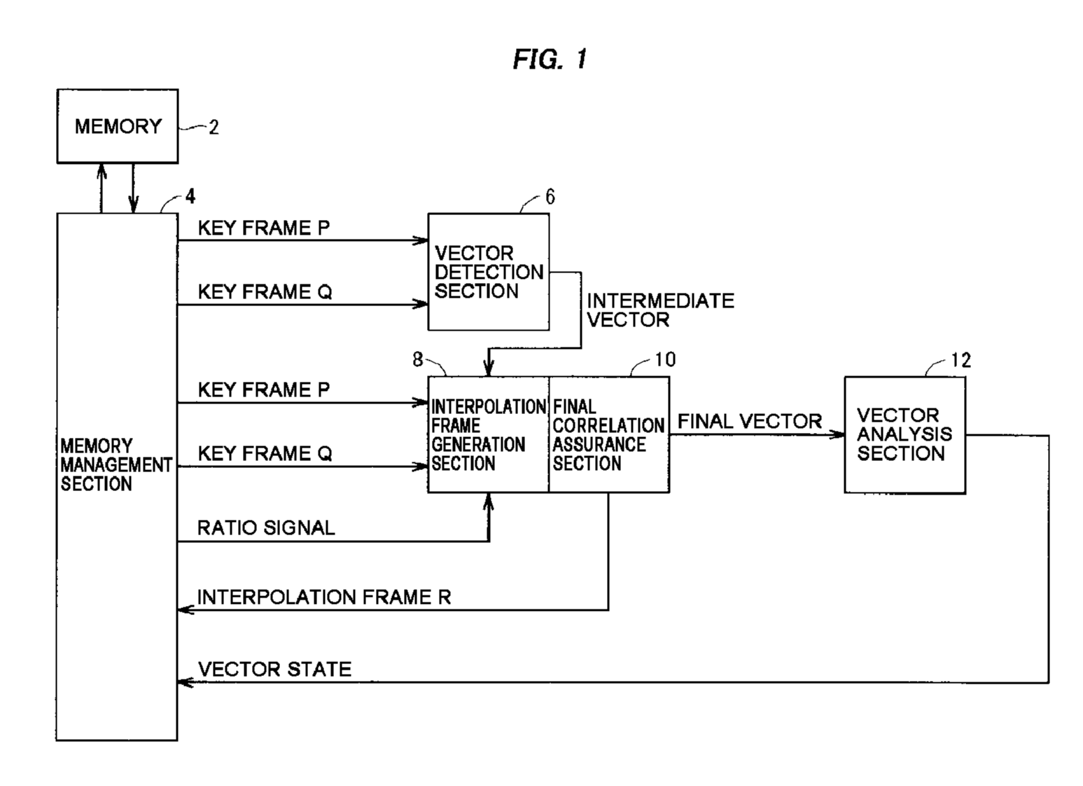

FIG. 1 is a block diagram illustrating a configuration example of a frame rate conversion section according to an embodiment of the present invention.

Referring to FIG. 1, the frame rate conversion section comprises a memory 2, a memory management section 4, a vector detection section 6, an interpolation image generation section 8, a final correlation assurance section 10, and a vector analysis section 12.

The memory 2 has a plurality of frame data of an input image signal stored therein, and transfers/receives the frame data to/from the memory management sections 4.

The memory management section 4 reads the frame data stored in the memory 2, and outputs the frame data to the vector detection section 6 and the interpolation image generation section 8, respectively, in order to generate an interpolation frame to be interpolated as an image signal between the consecutive frames of an input image signal.

This example shows a case where key frames P, Q, which are consecutive frame data, are being output to the vector detection section 6 calculating motion vectors. Moreover, this example also shows a case where the key frames P, Q are being output to the interpolation image generation section 8. Assume that the key frame P is chronologically the previous frame and the key frame Q is chronologically the subsequent frame.

The interpolation image generation section 8 generates, with respect to the frame data (key frames P, Q) respectively output from the memory management section 4, an interpolation frame based on an intermediate vector (motion vector) from the vector detection section 6 and a ratio signal from the memory management section 4. In this example, assume that the ratio signal (interpolation ratio) for generating the interpolation frame based on the key frames P, Q is set to 1/2 in the normal time.

The final correlation assurance section 10 is further associated with the interpolation image generation section 8, wherein the final correlation assurance section 10 calculates the certainty of the intermediate vector from the vector detection section 6, and performs a special processing on a vector with high ambiguity and corrects the intermediate vector. Then, the final correlation assurance section 10 generates an interpolation frame based on the corrected vector (final vector), and outputs the same to the memory management section 4. Then, the memory management section 4 stores the generated interpolation frame into the memory 2 as an image signal to be interpolated into the input image signal. The final correlation assurance section 10 outputs the corrected vector (final vector) to the vector analysis section 12.

The vector analysis section 12 determines the past image state using the final vector, and analyzes the vector state. The vector analysis section 12, if the calculated vector exceeded a vector evaluation calculation range in hardware, outputs to the memory management section 4 a vector state indicating that the calculated vector exceeded the vector evaluation calculation range. In the embodiment of the present invention, the memory management section 4 adjusts the ratio signal (interpolation ratio signal) based on the determination result of the vector analysis section 12.

Upon receipt of the vector state indicating that the calculated vector exceeded the vector evaluation calculation range from the vector analysis section 12, the memory management section 4 gradually adjusts the ratio signal from a predetermined ratio signal (1/2) to 0. Moreover, upon receipt of a vector state indicating that the calculated vector does not exceed the vector evaluation calculation range (that is, it is within this range) from vector analysis section 12 after setting the ratio signal to 0, the memory management section 4 gradually adjusts the ratio signal from the ratio signal 0 to the predetermined ratio signal (1/2). Note that, the ratio signal 0 means that the key frame P is output, as it is, as the interpolation frame.

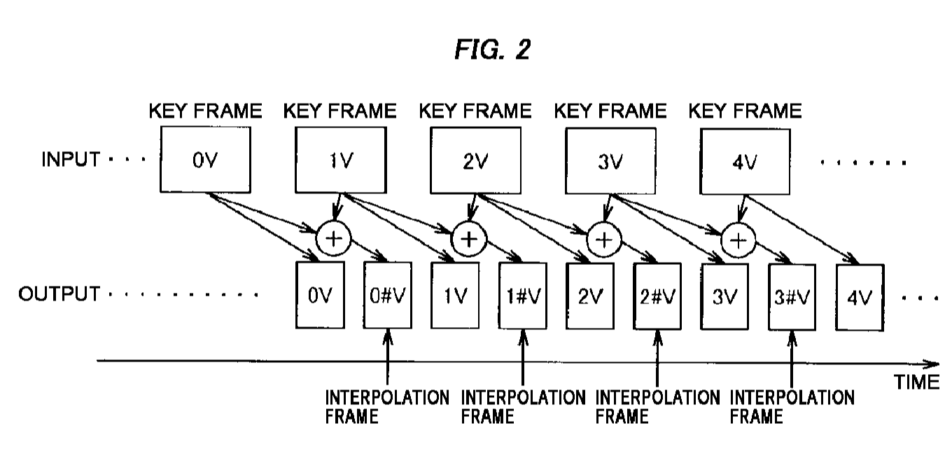

FIG. 2 is a view illustrating the generation of an interpolation frame using key frames. Referring to FIG. 2, first, the motion vector of a key frame is detected. An interpolation frame is generated by combining two key frames (the previous frame and subsequent frame) based on this motion vector. The generated interpolation frame is inserted between two key frames and output. This processing enables to convert the frame rate of an input image signal from 60 frames per second (60 Hz) to 120 frames per second (120 Hz).

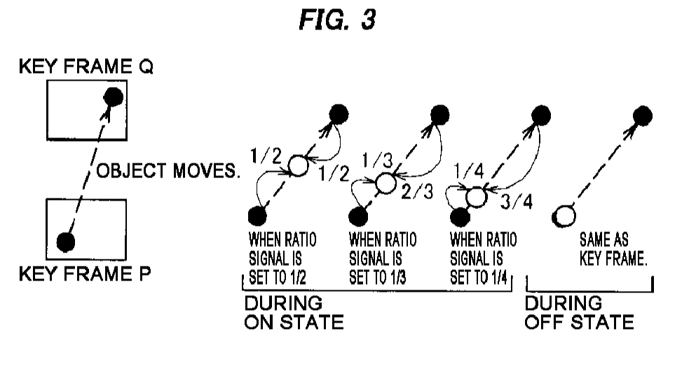

FIG. 3 is a view illustrating the interpolation ratio when an interpolation frame is generated. Referring to FIG. 3, the interpolation frame is generated according to the ratio signal from the memory management section 4.

Specifically, when the interpolation is ON, an interpolation frame is generated from the key frame P and the key frame Q according to the ratio signal (1/2, 1/3, and 1/4).

In contrast, when the interpolation is OFF, the key frame P (or the key frame Q) is inserted as the interpolation frame.

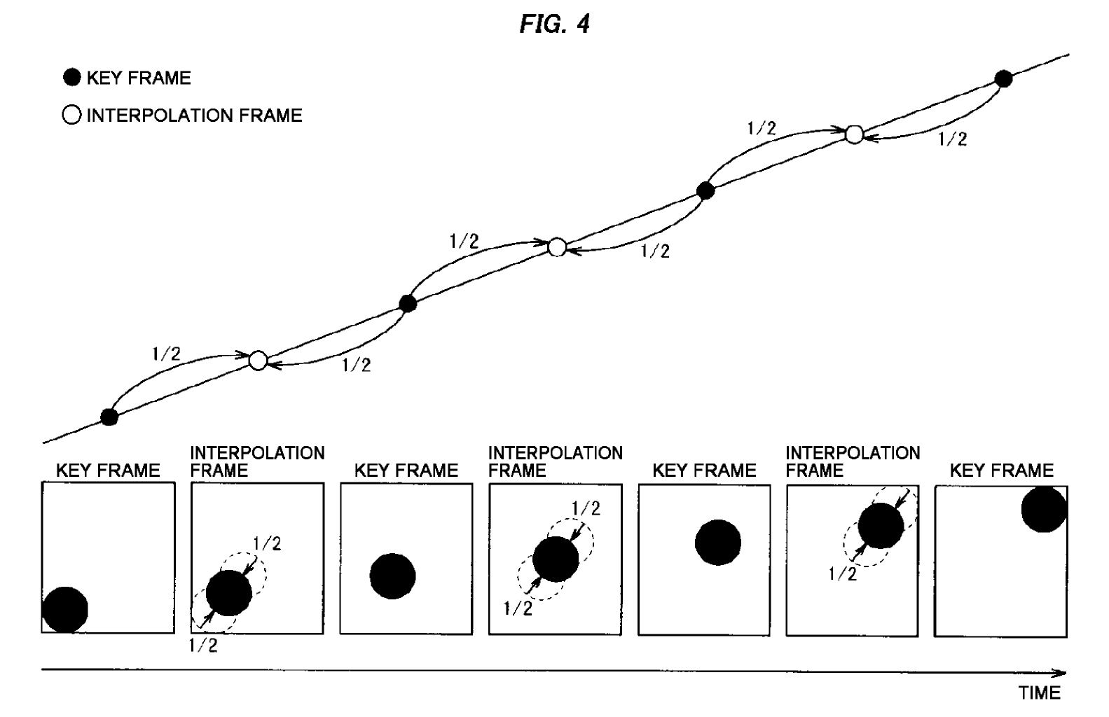

FIG. 4 is a view illustrating the generation of the normal interpolation frame using key frames when the ratio signal is set to 1/2.

Referring to FIG. 4, here is shown a case where for two key frames (the previous frame and subsequent frame), the interpolation frame is generated based on motion vectors when the ratio signal is set to 1/2.

Note that, here, the key frame is indicated by a filled circle and the interpolation frame is indicated by an open circle. The same is true of the subsequent drawings.

Next, the processing when the interpolation frame based on two key frames is not generated based on the vector state (indicating that the calculated vector exceeded the vector evaluation calculation range) from the vector analysis section 12 is described.

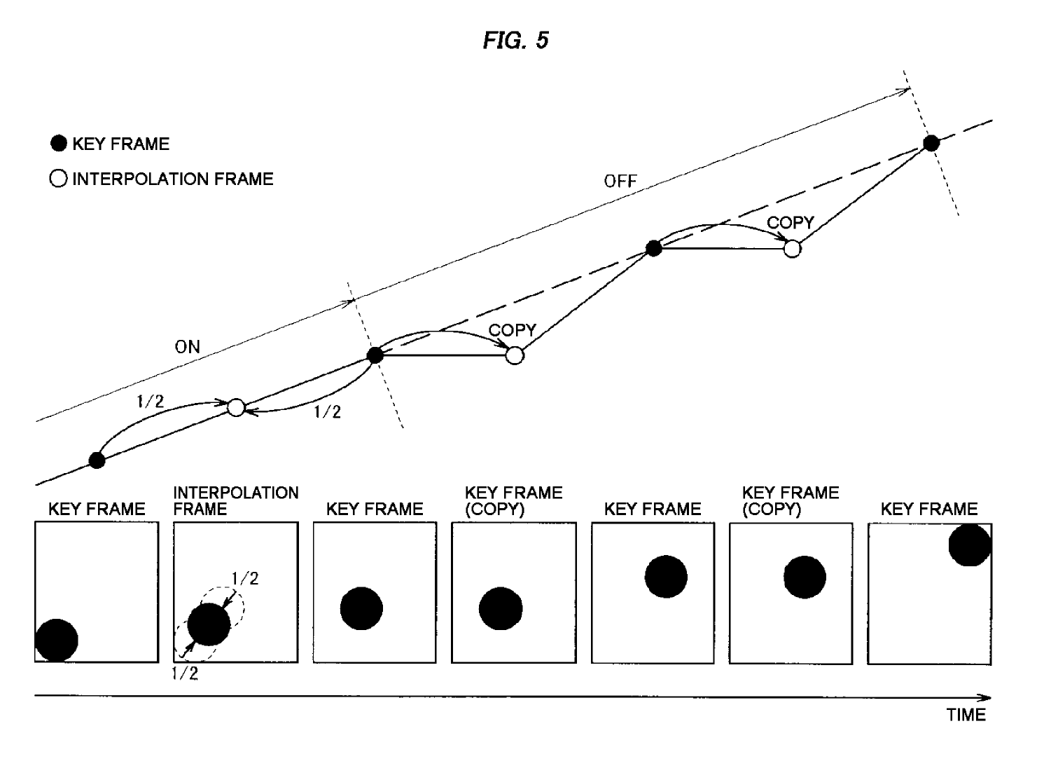

FIG. 5 is a view illustrating the conventional processing when the interpolation frame based on two key frames is not generated.

Referring to FIG. 5, here is shown a case where the output of an interpolation frame is turned off in the middle of the processing.

That is, a case is shown where from the middle of the processing, the ratio signal 1/2 is changed to the ratio signal 0 and the interpolation frame which is an exact copy of the previous frame is output.

As shown in this view, since the interpolation frame is an exact copy of the previous frame, the image becomes an unnatural image at a time point of the boundary for turning on/off the output of the generated interpolation frame.

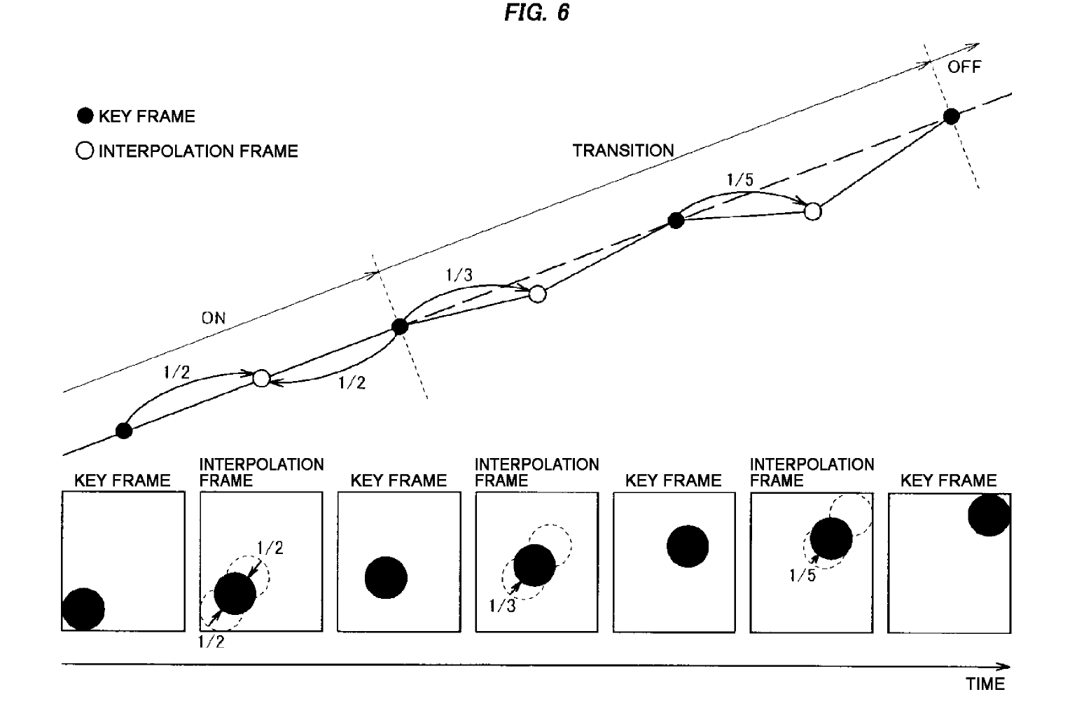

FIG. 6 is a view illustrating the generation of an interpolation frame according to the embodiment of the present invention. Referring to FIG. 6, in this embodiment, the ratio signal is gradually adjusted for each interpolation frame according to the vector state (indicating that the calculated vector exceeded the vector evaluation calculation range) from the vector analysis section 12.

Specifically, here is shown a case where an interpolation frame is generated with the ratio signal 1/2 adjusted to 1/3, and then, furthermore, an interpolation frame is generated with the ratio signal 1/3 adjusted to 1/5, and subsequently an interpolation frame is generated with the ratio signal set to 0.

Accordingly, the ratio signal gradually approaches 0 without the ratio signal steeply changing from the ratio signal 1/2 to the ratio signal 0. Therefore, it is possible to process the input image signal so as not to give a viewer a feeling of unnaturalness even when a crash occurs, without the output image becoming an unnatural image at a time point of the boundary for turning on/off the output of the generated interpolation frame.

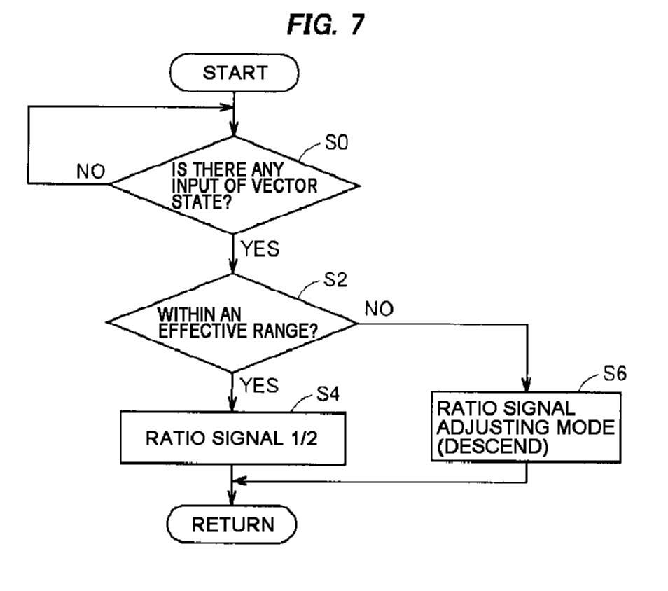

FIG. 7 is a flow diagram illustrating the adjustment processing from the ratio signal 1/2 in the memory management section 4 according to the embodiment of the present invention.

Referring to FIG. 7, first, it is determined whether there is any input of a vector state (Step S0). Specifically, it is determined whether there is any input of a signal of the vector state from the vector analysis section 12.

In Step S0, if it has been determined that there is an input of a vector state (YES in Step S0), then based on the vector state, it is determined whether the vector evaluation calculation range is within an effective range (Step S2).

In Step S2, if it has been determined based on the vector state that the vector evaluation calculation range is not within the effective range (NO in Step S2), then the flow moves to a ratio signal adjusting mode. In this case, the ratio signal is adjusted in a direction of gradually approaching 0 from 1/2. Then, the processing is completed (returned). With regard to the adjustment of the ratio signal, once having moved to the ratio signal adjusting mode, first, as an example, the ratio signal is set to 1/3 in generating an interpolation frame, and then in the next interpolation frame, the ratio signal is set to 1/5. Then, the ratio signal is set to 0 in the generation of the next interpolation frame. After setting the ratio signal to 0 in generating an interpolation frame for several frames, and next, based on whether the vector evaluation calculation range is within the effective range, the ratio signal is re-adjusted.

In contrast, in Step S2, if it has been determined based on the vector state that the vector evaluation calculation range is within the effective range (YES in Step S2), the ratio signal is set to 1/2 (Step S4). Then, the processing is completed (returned).

Accordingly, from the state of the ratio signal 1/2, once determined based on the vector state that the vector evaluation calculation range is not within the effective range, the ratio signal gradually approaches 0 from 1/2 and finally the ratio signal is set to 0.

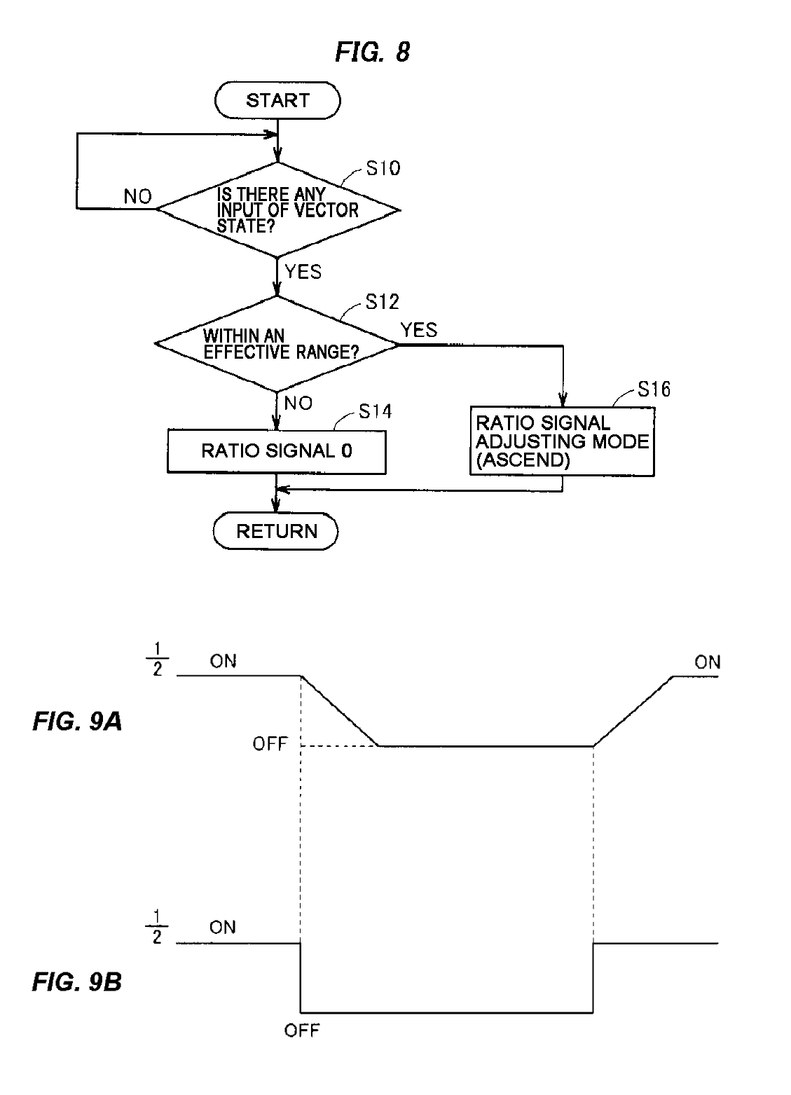

FIG. 8 is a flow diagram illustrating the adjustment processing from the ratio signal 0 in the memory management section 4 according to the embodiment of the present invention.

Referring to FIG. 8, first, it is determined whether there is any input of a vector state (Step S10). Specifically, it is determined whether there is any input of a signal of the vector state from the vector analysis section 12.

In Step S10, if it has been determined that there is an input of a vector state (YES in Step S10), then, based on the vector state, it is determined whether the vector evaluation calculation range is within the effective range (Step S12).

In Step S12, if it has been determined based on the vector state that the vector evaluation calculation range is not within the effective range (No in Step S12), the ratio signal is set to 0 (Step S14). Then, the processing is completed (returned).

In contrast, in Step S12, if it has been determined, based on the vector state, that the vector evaluation calculation range is within the effective range (YES in Step S12), the flow moves to the ratio signal adjusting mode. In this case, the ratio signal is adjusted in a direction of gradually approaching 1/2 from 0. Then, the processing is completed (returned). With regard to the adjustment of the ratio signal, once having moved to the ratio signal adjusting mode, first, as an example, the ratio signal is set to 1/5 in generating an interpolation frame, and then in the generation of the next interpolation frame, the ratio signal is set to 1/3. Then, the ratio signal is set to 1/2 in the generation of the next interpolation frame. Then, the normal interpolation frame of the ratio signal 1/2 is generated.

Accordingly, from the state of the ratio signal of 0, once having determined based on the vector state that the vector evaluation calculation range is within the effective range, the ratio signal would gradually approach 1/2 from 0 this time, and finally the ratio signal is set to 1/2.

FIG. 9A is a view illustrating a change in the ratio signal of the embodiment of the present invention. Referring to FIG. 9B, here is shown the conventional case where the ratio signal 1/2 steeply changes to the ratio signal 0. As shown in FIG. 9A, by gradually changing the ratio signal 1/2, the processing can be performed so as not to give a viewer a feeling of unnaturalness, without generating an unnatural image at a time point of the boundary for turning on/off the output of the generated interpolation frame.

Note that, in this example, a case has been described wherewith the use of the gradient method as the motion vector detection method, the ratio signal is adjusted based on whether or not the vector evaluation calculation range is within the effective range, however, the present invention is also applicable to the case where the block matching method is used, for example. Specifically, the ratio signal may be adjusted based on whether or not the vector evaluation calculation range exceeds a vector search range.

### ALTERNATIVE EMBODIMENTS

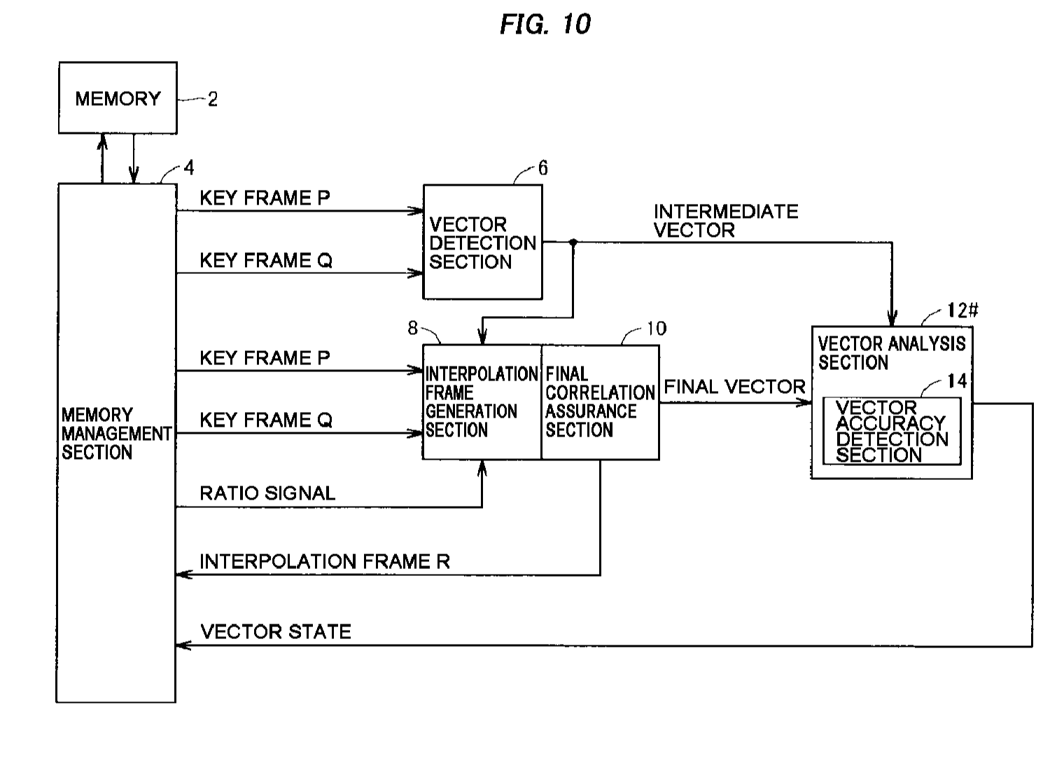

FIG. 10 is a block diagram illustrating a configuration example of a frame rate conversion section according to an alternative embodiment of the present invention.

Referring to FIG. 10, the frame rate conversion section according to the alternative embodiment differs from FIG. 1 in that the vector analysis section 12 is replaced with a vector analysis section 12.

The vector analysis section 12 includes a vector accuracy detection section 14. The vector accuracy detection section 14 calculates the accuracy of an intermediate vector based on the intermediate vector and the final vector. If an error between the intermediate vector and the final vector is large, the calculated value becomes large.

The vector accuracy is calculated according to the following formula.

$$Vector accuracy = 20 \times log 10 \frac{\vert maximum vector quantity \vert}{\sqrt{{\sum }_{k = 0}^{k = n - 1} \vert intermediate vector k - final vector k \vert}}$$

Where n represents the pixel number within one screen.

Note that the maximum vector quantity means the maximum vector quantity among the intermediate vectors and final vectors within one screen.

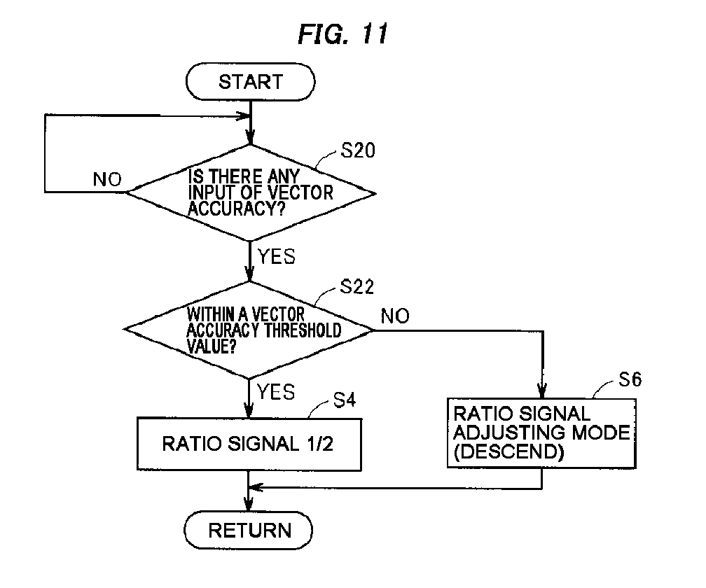

FIG. 11 is a flow diagram illustrating the adjustment processing from the ratio signal 1/2 in the memory management section 4 according to the alternative embodiment of the present invention.

Referring to FIG. 11, the flow of FIG. 11 differs from FIG. 7 in that Steps S20, S22 are provided in place of Steps S0, S2. Specifically, first, in Step S20, it is determined whether there is any input of a signal indicative of vector accuracy from the vector analysis section 12.

In Step S20, if it has been determined that there is an input of the signal of vector accuracy (YES in Step S20), then based on the vector accuracy, it is determined whether the vector accuracy is within a predetermined threshold value (Step S22).

If it has been determined in Step S22 that the vector accuracy is not within the predetermined threshold value (No in Step S22), the flow moves to the ratio signal adjusting mode (Step S6). The ratio signal adjusting mode is the same as the one described in FIG. 7.

In contrast, if it has been determined in Step S22 that the vector accuracy is within the predetermined threshold value (YES in Step S22), the ratio signal is set to 1/2 (Step S4). Then, the processing is completed (returned).

Accordingly, from the state of the ratio signal 1/2, once determined based on the vector accuracy that the vector accuracy is not within the predetermined threshold value, the ratio signal gradually approaches 0 from 1/2 and finally the ratio signal is set to 0.

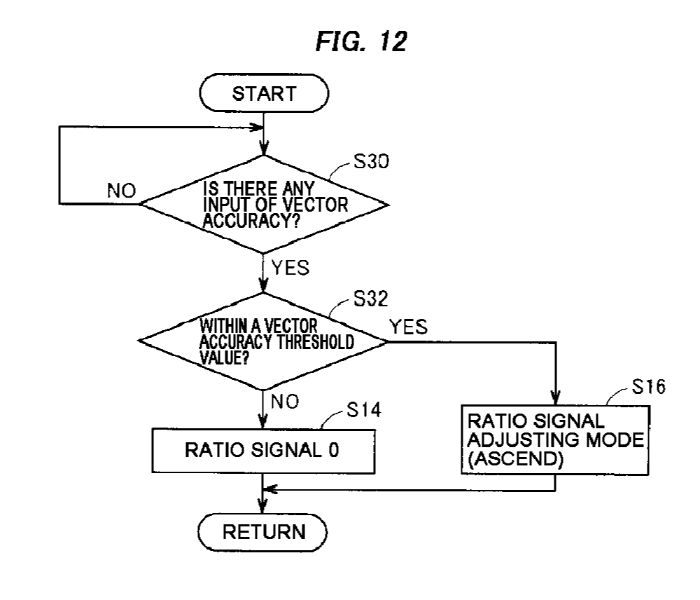

FIG. 12 is a flow diagram illustrating the adjustment processing from the ratio signal 0 in the memory management section 4 according to the alternative embodiment of the present invention.

Referring to FIG. 12, the flow of FIG. 12 differs from FIG. 7 in that Steps S30, S32 are provided in place of Steps S10, S12. Specifically, first, in Step S30, it is determined whether there is any input of the signal of vector accuracy from the vector analysis section 12.

If it has been determined in Step S30 that there is an input of the signal of vector accuracy (YES in Step S30), then based on the vector accuracy, it is determined whether the vector accuracy is within a predetermined threshold value (Step S32).

In Step 32, if it has been determined based on the vector state that the vector evaluation calculation range is not within the effective range (NO in Step S32), then the ratio signal is set to 0 (Step S14). Then, the processing is completed (returned).

In contrast, in Step S32, if it has been determined, based on the vector state, that the vector evaluation calculation range is within the predetermined threshold value (YES in Step S32), then the flow moves to the ratio signal adjusting mode. The ratio signal adjusting mode is the same as the one described in FIG. 8.

Accordingly, from the state of the ratio signal 0, once determined, based on the vector accuracy, that the vector accuracy is within the predetermined threshold value, the ratio signal gradually approaches 1/2 from 0 this time, and finally the ratio signal is set to 1/2.

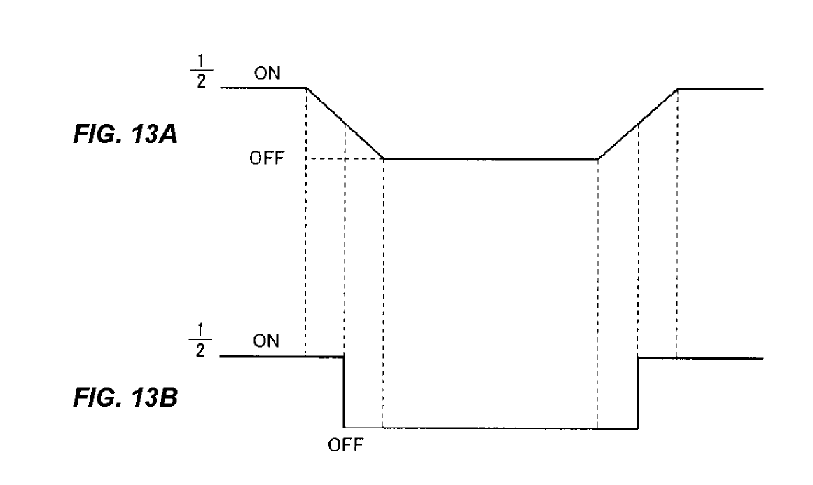

FIG. 13A is a view illustrating a change in the ratio signal according to the alternative embodiment of the present invention.

Referring to FIG. 13B, here is shown a conventional case where the ratio signal 1/2 steeply changes to the ratio signal 0. As shown in FIG. 13A, by gradually changing the ratio signal 1/2, the ratio signal adjustment processing can be performed so as not to give a viewer a feeling of unnaturalness, without generating an unnatural image at a time point of the boundary for turning on/off the output of the generated interpolation frame.

Moreover, appropriate setting of the threshold value makes it possible to move to the ratio signal adjusting mode at a timing earlier than the conventional timing. Thus, the ratio signal adjustment processing can be performed so as not to give a viewer a feeling of unnaturalness, without generating an unnatural image at a time point of the boundary for turning on/off the output of the generated interpolation frame.

Note that, in the above description, the frame rate conversion (frame interpolation) of a frame image is performed. However, this image data may be the image data of interlace system wherein one normal frame comprises two fields. That is, an intermediate image may be generated from a plurality of images so as to convert the image display rate. That is, the frame rate conversion section (the image processing device) of the present invention can be applied to any configuration to create a new image by image comparison between a plurality of images.

Moreover, the display device is not limited to the liquid crystal display device, but may be other display device. Note that, the above-described formula where the vector accuracy is calculated by numerizing an error between two samples is just an example, and of course the vector accuracy can be detected using other formula.

Note that, a method of causing a computer to execute the control described in the aforementioned flow diagrams, or a program to implement this method may be provided. Such a program may be recorded on a non-temporary computer-readable record medium, such as a flexible disk attached to a computer, a CD-ROM (Compact Disk-Read Only Memory), a ROM (Read Only Memory), a RAM (Random Access Memory), or a memory card, and the resulting medium may be provided as a program product. Alternatively, such a program may be recorded on a record medium, such as a hard disc incorporated in a computer, so as to be provided as the program. Moreover, such a program may be provided through downloading via a network.

Note that, such a program may be a program to call necessary modules among the program modules, which are provided as apart of the operation system (OS) of a computer, in a predetermined arrangement at predetermined timings and cause the modules to execute the processing. In this case, the program itself does not include the above-described modules, and the processing is performed by the program in cooperation with the OS. The program according to the present invention may include such a program without the modules.

Moreover, the program according to the present invention may be provided as being incorporated in a part of other program. Also in such a case, the program itself does not include the modules included in other program, and the processing is performed by the program in cooperation with other program. The program according to the present invention may include such a program incorporated in other program.

The program product provided is installed in a program storage section, such as a hard disc, and is executed. Note that the program product includes the program itself and a record medium having the program recorded thereon.

All the embodiments disclosed here should be considered to be illustrative only in every respect but not restrictive. The scope of the present invention is indicated not by the aforementioned descriptions but by the scope of the appended claims. The scope of the present invention is intended to include the meaning equivalent to the appended claims and all the modification within the scope of the present inventions.

What is claimed is:

1. An image processing device converting the number of frames of an input image signal by interpolating an image signal between consecutive frames of the input image signal, the image processing device comprising:
a motion vector calculation section calculating a motion vector based on one of the consecutive frames of the input image signal, and the other frame;
a vector analysis section determining reliability of a motion vector calculated by the motion vector calculation section;
an interpolation ratio setting section setting an interpolation ratio for interpolating between one of the consecutive frames and the other frame based on an analysis result of the vector analysis section; and
an interpolation frame generation section generating an interpolation frame for interpolating between one of the consecutive frames and the other frame based on the motion vector calculated by the motion vector calculation section and the interpolation ratio, wherein
the interpolation ratio setting section gradually changes the interpolation ratio from a predetermined interpolation ratio based on the analysis result of the vector analysis section.

2. The image processing device according to claim 1, further comprising a correction section correcting a motion vector calculated by the motion vector calculation section, wherein
the interpolation frame generation section generates the interpolation frame based on a corrected motion vector, and wherein
the vector analysis section further comprises an accuracy determination section determining reliability of a motion vector calculated by the motion vector calculation section, based on a motion vector corrected by the correction section and a motion vector calculated by the motion vector calculation section.

3. The image processing device according to claim 1, wherein if it has been determined based on an analysis result of the vector analysis section that the interpolation frame would crash, the interpolation ratio setting section gradually changes the predetermined interpolation ratio so as to be 0.

4. The image processing device according to claim 3, wherein after setting the interpolation ratio to 0, the interpolation ratio setting section, if it has been determined based on the analysis result of the vector analysis section that the interpolation frame would not crash, gradually changes the interpolation ratio so as to be the predetermined interpolation ratio from 0.

5. An image processing method for converting the number of frames of an input image signal by interpolating an image signal between consecutive frames of the input image signal, the method comprising the steps of:
calculating a motion vector based on one of the consecutive frames of the input image signal, and the other frame;
determining reliability of a calculated motion vector;
setting an interpolation ratio for interpolating between one of the consecutive frames and the other frame based on a determination result; and
generating an interpolation frame for interpolating between one of the consecutive frames and the other frame based on the calculated motion vector and the interpolation ratio, wherein
the step of setting the interpolation ratio comprises the step of gradually changing the interpolation ratio for each interpolation frame from a predetermined interpolation ratio based on the analysis result.
